(19) United States
(12) Patent Application Publication
(10) Pub. No.: US 2013/0014464 A1
(43) Pub. Date: Jan. 17, 2013

(54) WOODEN LAMINATED FLOOR FOR THE TRANSPORT INDUSTRY COMPOSED OF SOFTWOOD LUMBER

(71) Applicants: Benoit RISI, Cap St-Ignace (CA); Guillaume Berube, Levis (CA)

(72) Inventors: Benoit RISI, Cap St-Ignace (CA); Guillaume Berube, Levis (CA)

(73) Assignee: PROLAM, SOCIETE EN COMMANDITE, Cap St-Ignace (CA)

(21) Appl. No.: 13/548,610

(22) Filed: Jul. 13, 2012

Related U.S. Application Data
(60) Provisional application No. 61/507,675, filed on Jul. 14, 2011.

(51) Int. Cl. B62D 25/20; E04B 5/12

(52) U.S. Cl. 52/592.1

(57) ABSTRACT

A cargo carrying flooring system, made of planks of wood arranged side by side. Each plank is made of a plurality of rows of wood strips, the strips being connected end to end by shaped coupling portions, and side by side. At least some of the rows of wood strips are made of machine graded softwood lumber.

This application claims benefit of Ser. No. 61/507,675, filed 14 Jul. 2011 in the United States and which application is incorporated herein by reference. To the extent appropriate, a claim of priority is made to each of the above disclosed applications.

### FIELD OF THE INVENTION

The invention concerns the use of softwood, especially softwood lumber, which is machine-graded for its structural properties (like stamped MSR or MEL softwood lumber for example), to make a wooden cargo-carrying laminated floor. The result is a wooden cargo-carrying laminated floor that is lighter than the current laminated hardwood floors used in North America, which reduces the fuel costs and increases the pay load of freight companies. Another advantage of the present invention is that the ratio of cost to pound is less than the current composite floor products currently used in the North American transport industry.

### BACKGROUND OF THE INVENTION

In the past decade, the research and development efforts for new products in the manufacturing industry of conventional laminated floor have mainly focused on the development of a floor using composite materials to increase the durability, the strength and/or the moisture protection of the cargo-carrying laminated trailer/container floor. The weight of these new composite floors should, at minimum, be the same or preferably less than a conventional floor made exclusively with hardwood. Furthermore, all of the objectives should be reached at the lowest manufacturing cost.

Solutions to resolve these problems have been proposed by many in this field, and more recently by Padmanabhan U.S. Pat. No. 5,928,735, Tunis U.S. Pat. No. 6,601,357 and Risi U.S. Pat. No. 7,637,558 B2.Padmanabhan applies the well-known reinforcement technology to a specific trailer floor application. Padmanabhan glues a reinforced thermoset or thermoplastic ply to the entire bottom of the floor. Because the fibreglass ply reinforces the tension zone (bottom of the floor) and increases its modulus of rupture, the hardwood portion of the floor can be thinner. The result is a floor with higher fatigue resistance to the passages of a forklift and is a lighter trailer floor. The reinforced ply also provides a water impervious layer protecting the entire bottom part of the floor from moisture coming from the road.

Tunis provides a solution for moisture protection only. The thermoplastic ply is not reinforced and has as its sole purpose the protection of the floor from the attack of water spray and moisture over time. The thermoset or thermoplastic ply covers the entire bottom surface of the floor.

The above-mentioned patents implicitly appear to be based on the same assumption: the entire surface and bottom area of the laminated hardwood cargo-carrying floors are exposed equally over the time to the same accumulation of the effects of stress and/or moisture attack. Based on that assumption, all the proposed solutions described in the above-mentioned patents necessarily require that the remedy needs to be applied to the entire surface of the bottom part of the laminated hardwood floor. Furthermore, the reinforced and/or impervious moisture ply has the same thickness or the same degree of reinforcement or moisture protection all over the bottom floor.

In reality, different sections of the laminated hardwood cargo-carrying floor are subject to different effects of stress or exposition to moisture over time. Risi provides a solution where reinforcement and/or moisture protection are applied on area of the floor where it is needed. As far as reducing the weight of the floor, the solutions provided by Padmanabhan and Risi are based on the composite concept: using another material which has better mechanical properties than the wood, like fibreglass, to reinforce the wooden floor which will then permit a reduction in the quantity of wood used to make the floor, with a view to reduce the weight. This concept by itself is good, but it is relatively expensive because of the cost of the fibreglass membrane itself, and the operating cost of gluing the fibreglass membrane to the bottom wood part of the floor. Currently, the manufacturing cost of a composite floor lies between 1.30 and 1.65 $US per sq.ft. more than a 100% conventional hardwood floor, for a weight saving of 0.5 to 0.7 pounds per sq.ft., for a ratio “$/pound saving” of between 2.15 to 3.25.

The conclusion of the above leads one to investigate whether there are other solutions possible to avoid using any type of reinforced membrane and produce a lighter floor at a lower cost.

The present invention shows, that it is possible to review the method of manufacture of hardwood floors to decrease the weight of the floor without significantly comprising strength, stiffness and durability, at an effective cost. To be able to understand and appreciate its value, it is important at this point to review how conventional wood floors are currently manufactured in North America, the concept of machine-graded lumber and the mechanical properties of the laminated floor.

Review of the Current Manufacturing Process of Conventional Wood Flooring

The manufacturing of conventional laminated hardwood boards for trailers and containers floors in North America is well described in previous patents like Padmanabhan U.S. Pat. No. 5,928,735 and Tunis U.S. Pat. No. 6,601,357.

Conventional laminated wooden floor uses hardwood species like white and red oaks, hard and red maples, birches, and any other hardwood species which may have the appropriate mechanical and physical properties. The green hardwood lumber used as a starting material in such manufacture is suitably dried in special drying chambers under controlled conditions. The dried hardwood lumber is then sanded and sawed into strips of rectangular cross-section and defective portions are eliminated by cross cutting the strips (the width of the strips is in fact the thickness of the floor). After, with a double end matching or during the cross cutting process, hooks or knuckle are formed at the ends of the hardwood strips. The joints are a simple mechanical coupling between the ends of opposing hardwood strips without significant adhesive bonding at the joint itself.

Recent manufacturing improvements coming from the most capable North American producers have permitted the use of structural finger joints in laminated hardwood floor providing a superior fatigue resistance than conventional laminated floor using non structural joints like hook joints. The use of structural joints in laminated hardwood floor produced in North America is still in its infancy, so the majority of the joints are still non-structural like the hook or knuckle joints. For the purposes of the present invention, it is assumed that the end joints are non-structural, such as the hook or the knuckle shaped joint. In engineered products like Glulam beam, or roof trusses, a structural end joint, like the finger joints, should reach at least 70% to 80% of the strength of the wood itself.

The relatively defect-free hardwood lumber strips are coated on their vertical sides or edges with an adhesive such as urea-melamine formaldehyde or polyvinyl acetate. The lengths of the strips are random. The minimum length of the hardwood lumber strips is 12 inches as requested by industry standard and a maximum length of 6 to 7 feet, which is limited by the width of the double end matcher equipment which makes the desired profile of the joint. The uncured edge-glued hardwood strips are then assembled by hand on a conveyor which is at the entrance of a glue press, by placing them side-by-side and one in front of other strips, which were previously assembled. Then the adhesive is cured by applying heat and edge pressure to large sections of the assembled hardwood lumber strip thus forming a unitary panel.

At the output of the press, the cured laminated wood is cut to a desired length (up to about 60 feet) and width (about 6 to 18 inches) to form boards. The boards are then planed to a desired thickness and shiplaps and crusher beads are machined on the sides.

A shiplap is a rectangular projecting ledge along the length on each side of a floorboard. The crusher bead is a small semi-circular projection running along the length on each side of a board and placed over or below a lip. When the floorboards are assembled in a trailer such that the side edges of corresponding boards are squeezed together, the shiplaps of adjacent boards overlap to form a seam. The crusher beads provide spacing between adjacent boards and help in preventing buckling of the boards due to expansion of the board following absorption of water. Wood putty is applied at the hook joints on the top and bottom surfaces of the boards to fill any gaps. Finally, the underside of the floorboards is coated with a polymeric substance termed as “undercoating” to provide moisture protection. The finished floorboards are assembled into a kit of about eight boards for installation in a trailer. Normally, a kit consists of two boards with special shiplaps so that they will fit along the road and curb sides of a trailer. The other boards may be identical.

In some trailers, a metallic component such as a hat-channel may be placed between any two adjacent boards. The metallic component becomes part of the floor area. The boards adjacent the hat-channel have machined edges designed to mate with the flanges of the metallic component. All the boards are supported by a sub-floor structure which is generally thin-walled cross-members of I, C or hat sections (FIG. 2), each having an upper flange or surface, which span the width of the trailer and are spaced along the length of the trailer. The distance between the cross-members can vary. In general, at the back of the trailer, near the rear door, the distance between the cross-members is usually less than 12 inches, around 6 or 8 inches for example, and then increases to 12 inch center. This is to provide more strength to the floor at the back where there are more passages of a forklift, creating more stress. Each floorboard is secured to the cross-members by screws or other appropriate fasteners extending through the thickness of the board and the upper flanges of the cross- members.

Laminated hardwood flooring is popularly used in truck trailers since it offers many advantages. The surface characteristics of hardwoods such as high wear resistance and slip resistance are most desirable. The strength and stiffness of the flooring is important for efficient and safe transfer of the applied loads to the cross-members of the trailer. The shock resistance of wood is useful to withstand any sudden dropping of heavy cargo on the floor. Nail holding capability and the ability to absorb small amounts of water, oil or grease without significantly affecting slip resistance are yet additional favourable properties of hardwood flooring.

Machine-Graded Lumber

This section is widely inspired by the ‘Wood handbook: Wood as an Engineering Material” Chapter 4 and 6, of the United State Department of Agriculture, General technical report FPL-GTR-113 and also from educational information provided by the MSR Lumber producers council (www.msrlumber.org).

Wood is a natural material which grows, and because the tree is subject to many constantly changing influence (such as moisture, soil conditions, growing space etc.) the value of its mechanical properties, like modulus of rupture, modulus of elasticity, hardness, shear strength parallel to grain, etc., will vary considerably. Values of the most common used mechanical properties of different species (like the one tabulated in the chapter 4 of the “Wood handbook; Wood as an Engineering Material”) are averages which are derived from extensive sampling and analysis. Like any other natural phenomena, the value of the mechanical properties of each plank coming from a plank population, will be “normally distributed”, meaning that the value of the majority of the planks will be around the average value of the plank population, and the planks which have the lower and the highest value will be in minority and equally shared in both extremes. The idea then is to use this variability of the mechanical properties of a plank population for a specific species by using the planks of this population which have the highest structural value for specific engineered components and structures purpose like roofing trusses, Glulam beam, etc.

Machine-graded lumber is a softwood lumber¹ evaluated by a machine using a non-destructive test followed by visual grading to evaluate other characteristics that the machine cannot or may not properly evaluate. Today, there are mainly two major types of machines which identify and classify the lumber on the basis of direct measurement of either the stiffness or the density of the lumber. The stiffness and the density are measured because they are highly correlated with other mechanical properties. It follows that a piece of wood which is stiffer or denser has good chance of also being stronger, harder, or have a high level of bending stress. ¹Although there is an interest in using hardwood species in engineered structures like timber bridges, glulam beams, trusses, etc., machine grading system has mainly been used for softwood lumber. Machine-graded hardwood lumber is fairly recent and has been subject of series of laboratory and studies conducted by the USDA Forest Products Laboratory in the 90's. For the purposes of the present, the word “lumber” in the term machine graded lumber refers to softwood species, unless it is specified otherwise.

Softwood which has been machine graded is identified by the grade stamp of a lumber grading agency approved by either the American Lumber Standard Committee or the Canadian Lumber Standards Accreditation Board. There are mainly two grade stamps: Machine Stress rated Lumber (MSR) and Machine Evaluated Lumber (MEL). They differ in grade names, quality control and coefficient of variation for the E values (modulus of elasticity). For MSR, the grade stamp includes both the allowable bending stress and bending stiffness. For the MEL the grade stamp adds the allowable tension stress and, optionally, the allowable compression stress.

TABLE 1
Example of Mel and MSR Grade stamps

| | |
|---|---|
| 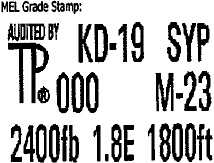 | 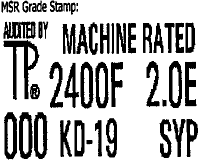 |

The following Table 2 shows common grades for machine-graded lumber² ²“Wood handbook: Wood as an Engineering Material” Chapter 6, of the United State Department of Agriculture, General technical report FPL-GTR-113 page 8

| | F_{b} | | E | | Fₜ | | F_{c∥} | |
|---|---|---|---|---|---|---|---|---|
| Grade name | (MPa (lb/in²)) | | (GPa (×10⁶ lb/in²)) | | (MPa (lb/in²)) | | (MPa (lb/in²)) | |
| MSR | | | | | | | | |
| 1350f-1.3E | 9.3 | (1,350) | 9.0 | (1.3) | 5.2 | (750) | 11.0 | (1,600) |
| 1450f-1.3E | 10.0 | (1,450) | 9.0 | (1.3) | 5.5 | (800) | 11.2 | (1,625) |
| 1650f-1.5E | 11.4 | (1,650) | 10.3 | (1.5) | 7.0 | (1,020) | 11.7 | (1,700) |
| 1800f-1.6E | 12.4 | (1,800) | 11.0 | (1.6) | 8.1 | (1,175) | 12.1 | (1,750) |
| 1950f-1.7E | 13.4 | (1,950) | 11.7 | (1.7) | 9.5 | (1,375) | 12.4 | (1,800) |
| 2100f-1.8E | 14.5 | (2,100) | 12.4 | (1.8) | 10.9 | (1,575) | 12.9 | (1,875) |
| 2250f-1.9E | 15.5 | (2,250) | 13.1 | (1.9) | 12.1 | (1,750) | 13.3 | (1,925) |
| 2400f-2.0E | 16.5 | (2,400) | 13.8 | (2.0) | 13.3 | (1,925) | 13.6 | (1,975) |
| 2550f-2.1E | 17.6 | (2,550) | 14.5 | (2.1) | 14.1 | (2,050) | 14.0 | (2,025) |
| 2700F-2.2E | 18.6 | (2,700) | 15.2 | (2.2) | 14.8 | (2,150) | 14.4 | (2,100) |
| 2850f-2.3E | 19.7 | (2,850) | 15.9 | (2.3) | 15.9 | (2,300) | 14.8 | (2,150) |
| MEL | | | | | | | | |
| M-10 | 9.7 | (1,400) | 8.3 | (1.2) | 5.5 | (800) | 11.0 | (1,600) |
| M-11 | 10.7 | (1,550) | 10.3 | (1.5) | 5.9 | (850) | 11.5 | (1,675) |
| M-14 | 12.4 | (1,800) | 11.7 | (1.7) | 6.9 | (1,000) | 12.1 | (1,750) |
| M-19 | 13.8 | (2,000) | 11.0 | (1.6) | 9.0 | (1,300) | 12.6 | (1,825) |
| M-21 | 15.9 | (2,300) | 13.1 | (1.9) | 9.7 | (1,400) | 13.4 | (1,950) |
| M-23 | 16.5 | (2,400) | 12.4 | (1.8) | 13.1 | (1,900) | 13.6 | (1,975) |
| M-24 | 18.6 | (2,700) | 13.1 | (1.9) | 12.4 | (1,800) | 14.5 | (2,100) |

^{a}Forest Products Society 1997. Other grades are available and permitted.
F_{b} is allowable 10-year load duration bending stress parallel to grain.
E is modulus of elasticity.
Fₜ is allowable 10-year load duration tensile stress parallel to grain.
F_{c∥} is allowable 10-year load duration compressive stress parallel to grain.

Since its initial development in the 1960s, machine graded lumber has been used primarily in engineered wood products. Metal plate-connected wood trusses, wood I- beams and glued-laminated timber are three examples. Some engineers and architects use machine graded lumber directly in framing applications to take advantage of its higher stiffness and strength properties.

Mechanical Properties of Laminated Hardwood Floor

The first desirable features of a laminated hardwood floor it is its hardness. The oaks, maples, birches and other species used to produce laminated floors are hard and usually 2 to 3 times harder than softwoods. The high level of hardness increases the shock and wear resistant of the floor: a laminated floor which will use softwood mixed with hardwood must be designed in such way to address this issue.

Another desirable feature is the strength of the floor which is the capacity of the floor to sustain a charge without failing. There are different ways to define a failure. A failure can be seen when a floor cannot support any more load (max. load capacity) or when the floor after having supported a charge, does not come back to its initial shape and maintains a permanent deformation (strength at its plasticity limit). Whatever the definition used to measure the strength, what is important is to compare identical values and be certain that when data are compared, the same things have been measured.

The other desirable feature of a laminated hardwood floor it is its stiffness, i.e. the capacity of the floor to resist flexing under the pressure of a charge. The stiffer the floor, the more it can spread efficiently the stress of a charge away and transfer it to the other components of the floor, like the cross member and the bottom rail wall.

A less known feature, but not less important, is the shear strength parallel to grain, especially for trailer and container applications. It is well known in the wood industry that when the ratio span/thickness is below 14, the shear strength parallel to grain level of the hardwood is as important as its tensile strength capacity. The span between cross members of trailer and container varies between 6 to 12 inches (but typically are 12 inches for trailer and 8 inches for containers). The thickness of the floor being 1⅛ to 1¾ then the ratio span/thickness will be below 14.

Another desirable and important feature of a laminated hardwood floor it is its stress resistance: the capacity of the floor to resist the repeated passage of a forklift when the goods are loaded and unloaded from the trailers or containers. The more a floor is able to sustain the stress related to the passage of the forklift, the higher is its durability and the longer will be its useful life. One of the design characteristics of the current laminated hardwood floor which affect the most the stress resistance of the floor is the number and the type of the end joints per square foot: the more there are non-structural end joints per square foot in a floor, the less the floor will be stress resistant to the passage of the forklift.

Consequently, because of the presence of the non-structural joints, the thickness of the current laminated hardwood floor has been higher to increase its strength and stiffness to compensate for the negative effects of the end joints. From here it can be said that if the number of non-structural joints per square foot or/and the effect of the non-structural end joints on the floor is reduced then for a given stress resistance level, the thickness of the floor can also be reduced so that the strength and the stiffness will also be, and then, the weight of the floor lower. It should be noted that one of the benefits of using a reinforced ply like proposed by Padmanabhan and Risi is to reduce the negative effects of the end joints. In a different way, if the end joints currently used would be structural joints like finger joints, the stress resistance of the floor would be higher and then the thickness of the floor could be further reduced (then less strong and less stiff) and then weight less.

### SUMMARY OF THE INVENTION

Dry van trailers, intermodal containers and truck bodies in North America³ use mainly laminated wooden floor which use the hardwoods species like the oaks, maples, birches, etc., because of their high level of strength, stiffness and hardness. The present invention teaches the manufacture of boards for the trailer industry, using softwood, especially softwood which preferably has been machine-graded, with or without hardwoods, without greatly compromising on the advantages of using only hardwood as a raw material. The result is a laminated floor using only softwood, or a mix of softwood and hardwood, as raw material which is a lighter wooden cargo-carrying laminated floor, reducing the fuel costs and increasing the payload of freight companies. ³In North America, floor for dry van trailers, intermodal containers, 16 feet and higher truck bodies or other applications not directly exposed to outside environment are mainly laminated floors which use the stronger, stiffer and harder hardwood the North American species like the white and red Oaks, the maples, the birches, the American beech, etc,. Aluminum floors are mainly used in the case of refrigerated trailers where cargo needs to be frozen or kept fresh like fruit, vegetable, meat, etc. Softwood and hardwood solid plank or softwood and hardwood plywood (softwood and hardwood products are never mixed together on a same floor) are used for light duty truck body (less the 16″ length) but also in flat and low bed when floor is directly exposed to outside condition

In accordance with one aspect of the invention, there is provided a cargo-carrying floor surface system for a cargo-carrying body comprising:
a. a cargo-carrying floor having a longitudinal length and lateral width, said floor comprising:
   a plurality of wood boards extending longitudinally up to a length substantially equal to the longitudinal length of said floor, each board having a top surface, a bottom surface opposite said top surface, and first and second side surfaces extending between said top surface and said bottom surface, where each of said wood boards has a width that is less than the lateral width of said floor, each of said wood boards being formed by a plurality of wood strips arranged end-to-end by shaped coupling portions and side-to-side to one another to form rows; said plurality of wood boards being arranged side by side and joined together at adjacent side surfaces to form said floor,
   wherein said floor has a top, a bottom opposite said top, first and second sides, a front, a back opposite to said front, a center area between said front and back, a center board area between said first and second sides and an outer board area extending out from said center board area to either said first or second sides;
   wherein at least some of said wood strips are machine graded softwood lumber.

Another aspect of the invention provides a cargo-carrying floor surface system for a cargo-carrying body comprising:
a. a cargo-carrying floor having a longitudinal length and lateral width, said floor comprising:
   a plurality of wood boards extending longitudinally up to a length substantially equal to the longitudinal length of said floor, each board having a top surface, a bottom surface opposite said top surface, and first and second side surfaces extending between said top surface and said bottom surface, where each of said wood boards has a width that is less than the lateral width of said floor, said plurality of wood boards being arranged side by side and joined together at adjacent side surfaces to form said floor,
   wherein said floor has a top, a bottom opposite said top, first and second sides, a front, a back opposite to said front, a center area between said front and back, a center board area between said first and second sides and an outer board area extending out from said center board area to either said first or second sides;
   wherein at least one of said planks is formed by a plurality of wood strips arranged end-to-end by shaped coupling portions and side-to-side to one another to form rows, and where some of said wood strips are machine graded softwood lumber.

Yet another aspect of the invention provides a cargo-carrying floor surface system for a cargo-carrying body comprising:
a. a cargo-carrying floor having a longitudinal length and lateral width, said floor has a top, a bottom opposite said top, first and second sides, a front, a back opposite to said front, a center area between said front and back;
b. said floor including at least a portion thereof that is made of wood, said at least a portion that is wood being formed by a plurality of wood strips arranged end-to-end by shaped coupling portions and side-to-side to one another to form rows, and where some of said wood strips are machine graded softwood lumber.

### BRIEF DESCRIPTION OF THE DRAWINGS

FIG. 1 is a prior representation of a laminated wood floor product, showing a portion of a wood plank;

FIG. 2 is a prior art representation of a laminated wood floor product, showing a wood plank on top of cross members in a trailer;

FIG. 3 shows a wood plank made with machine graded softwood lumber, according to an embodiment of the invention;

FIG. 4 shows a wood plank made with rows of alternating hardwood and machine graded softwood lumber, according to another embodiment of the invention, where the edge that has softwood is the same that has the top ship lap;

FIG. 5 is a plank similar to that of FIG. 4, where both edges of the plank are made of rows of hardwood;

FIG. 6 is a representation of a floor system, where the outer boards are made of machine graded softwood lumber, but the center boards are made of hardwood;

FIG. 7 is a representation of a floor system, where the bottom of the floor is made of machine graded softwood lumber, and the top is a layer of hardwood; and

FIG. 8 is a representation of a floor system according to the invention for a flat bed trailer.

### DESCRIPTION OF A PREFERRED EMBODIMENT OF THE INVENTION

The starting point of the present invention is to use softwood species which have the closest (equal and even higher would be the best) modulus of elasticity (MOE) of the current laminated hardwoods floor. The MOE of a laminated hardwood floor is usually around between 1.8 to 2.0 million psi at 8% moisture content. The most common North American softwood reaching that level are mainly the Douglas-fir family species, the black spruce, the western larch and the yellow pine species. For maximum results on the mechanical properties of the finished product, machine graded lumber should be used. For example, if the minimum MOE is 1.8 million psi then M-23 under MEL group or 2100f-1.8E under MSR group must be used as raw material.

### 100% Softwood Laminated Floor

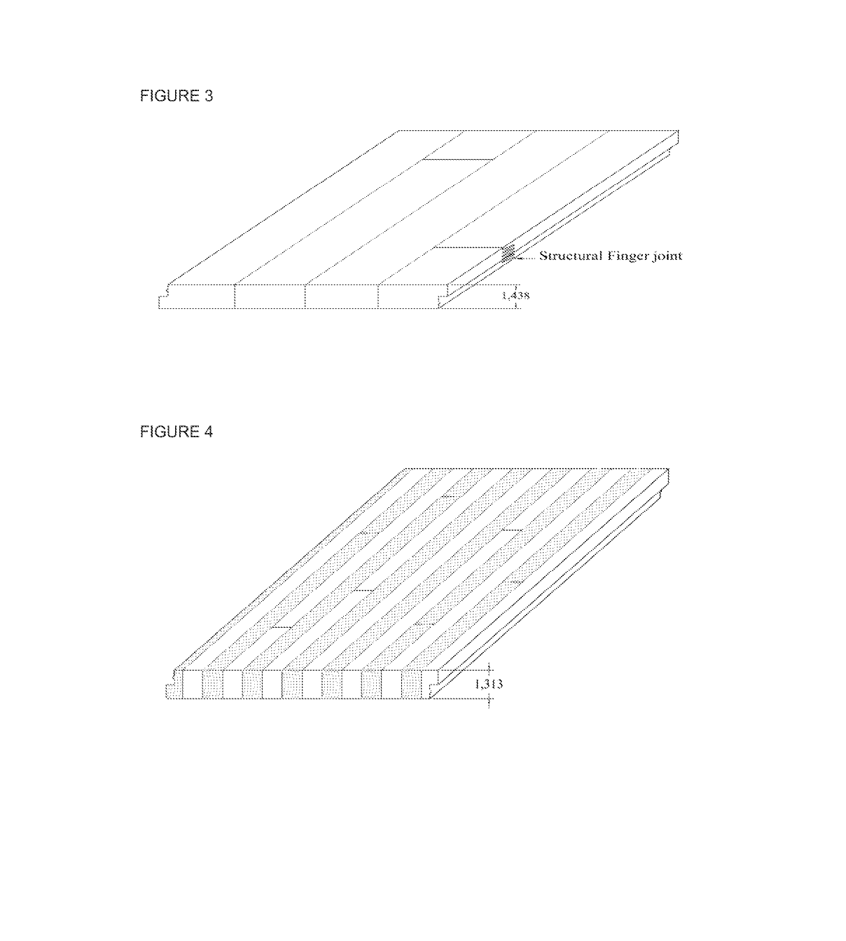

The first design which can be done is a laminated floor using only softwood lumber a portion of which is shown in FIG. 3. To reduce the manufacturing cost and optimize the uniformity of the mechanical value of the floor, it is preferable to use machine-grade lumber because it has higher quality: the knots, and/or any other wood defects do not affect structural properties.

This level of quality of machine-graded lumber enables the use of softwood without major transformation and loss of wood. Instead of laminated hardwood floors which are composed of 1600 and more hardwood sticks, a floor, for example, with a MSR 2100f-1.8E lumber 2″×3″ with an average of 8 feet long pieces, will have around 200 wood pieces. Furthermore, contrary to the laminated hardwood floor where end joint sticks are coupled with non-structural joints, floors which use softwood lumber preferably have structural finger joints for the end coupling of the lumber.

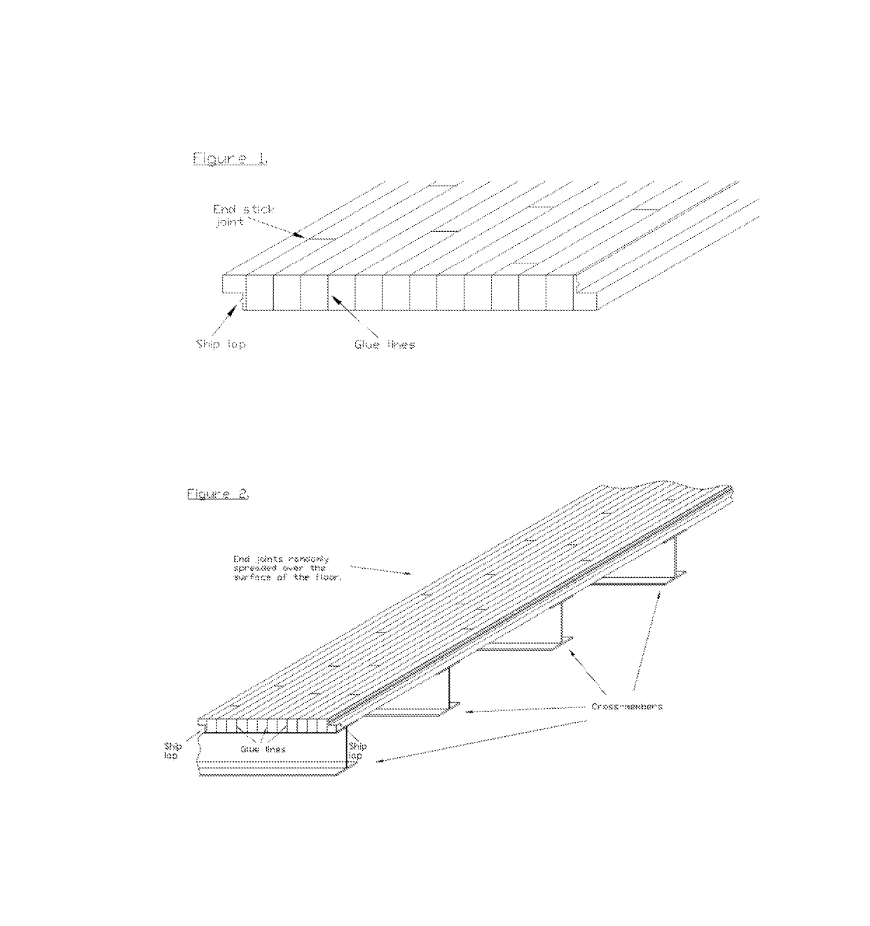

FIG. 3 shows a softwood laminated board (10) which used 2×4 softwood lumber (12). The 2″×4″ pieces have been planed, glued together and the coupling of the end joints is through finger joints (14). Compared to the current laminated hardwood floor, there are fewer rows because the machine-graded lumber is mainly used “as is” without major transformation. Machine-graded lumber could also be used in the same manufacturing process described in the prior art section instead of the hardwood. In this case, the lumber is transformed like the hardwood planks. The finished product will look exactly like the laminated hardwood floor (see FIG. 1) having several wood sticks glued together and non-structural end joints like hooks or knuckles.

The modulus of rupture of softwood being lower than hardwood, the thickness of a laminated softwood floor will need then to be higher to reach the same maximum load capacity. Table 3 shows the mechanical properties of laminated hardwood floor compared to laminate softwood floor using a group MSR 2100f-1.8E lumber for different thickness.

TABLE 3

| | Laminated | | | | |
|---|---|---|---|---|---|
| | hardwood⁴ | Laminated softwood | | | |
| | 1 5/16″ | 1 5/16′ | 1⅜″ | 1 7/16″ | 1½″ |
| MOR (psi) | 15 800 | 12 000 | 12 000 | 12 000 | 12 000 |
| Max. Load (lbd)¹ | 18 145 | 13 780 | 15 125 | 16 531 | 18 000 |
| MOE (000 000 psi) | 1.8 to 1.9 | 1.8 | 1.8 | 1.8 | 1.8 |
| Curvature²(inch) | .114 | .127 | .111 | .097 | .085 |
| Weight per sq. ft³. | 5.3 | 3.7 | 3.9 | 4.0 | 4.2 |

¹Board of 12″ wide on a 12 inches span
²Curvature under 8 000 pounds pressure on a 12 inches span
³Weight of the floor when the wood is at 12% moisture content
⁴Hardwood floor using oak species

Table 3 shows the advantages of using softwood for laminated floors. For a comparable maximum load capacity around 18 000 pounds, the 1½ inch thick laminated softwood floor is stiffer and lighter than the 1 5/16 laminated hardwood floor. Because the laminated softwood floor has fewer joints per square foot (because the sticks are longer) and/or use structural joints like finger joints, the floor is also stiffer, and a lower maximum load would be allowed without compromising the fatigue resistance of the floor. In consequence, a 1 7/16″, a 1⅜″ or maybe even a 1 5/16″ laminated softwood floor can be comparable in term of its stress resistance to a 1 5/16 laminated hardwood floor but with a much lower weight. Usually, the trailer floors for dry vans are around 375 sq.ft., which represents a weight saving of more than 480 pounds per trailer if 1 7/16 “laminated softwood floor is used instead of a 1 5/16″ laminated hardwood floor.

Wear and Abrasion Surface Resistance when Softwood is Used

As mentioned previously, one of the main advantages of using hardwood is its wear, shock and abrasive resistance. Hardwood is harder than softwood, and a floor made entirely of softwood may not have the same durability as a hardwood floor. Softwood could reduce the durability of the floor in term of its wear, shock and abrasive resistance.

The present invention teaches how to use softwood in laminated floor in such way to reduce the impact of softwood being less hard than hardwood.

The first way is to use laminated softwood floor board where there is less passage of a forklift. As RISI has pointed out in U.S. Pat. No. 7,637,558 B2, the two laminated boards which are along the dry van wall sustain less forklift passages than the middle laminate boards. Therefore, one way to use softwood is to use laminated softwood boards along the wall and use laminated hardwood boards in the middle. Because there are less forklift passages on the floor boards along the wall, the mechanical properties and the hardness of those boards do not need to be as high as the ones which are in the middle. Consequently, the laminated softwood floor boards could be used along the walls and have the same thickness as laminated hardwood board used in the middle of the floor. Such a floor, with laminated softwood boards along the walls and laminated hardwood boards in the middle, will then be approximately 150 pounds lower in weight.

Another manner to increase the wear, shock and abrasion resistance of a laminated softwood floor is to mix hardwood sticks and softwood sticks in the same laminated floor board in a manner that hardwood sticks are acting like a shield protecting the top surface of the softwood sticks (FIG. 4). The floor board of the FIG. 4 is done with 7 hardwood sticks (11) 0,9 inches wide and 7 softwood sticks (12), 0,9 inch wide. The surface of the floor is around 12 inches, and the overall width is 12,375. The weight of a 1,313 inch thick floor board per sq.ft is around 4.5-4.7. This represents a weight saving of 250 to 300 pounds.

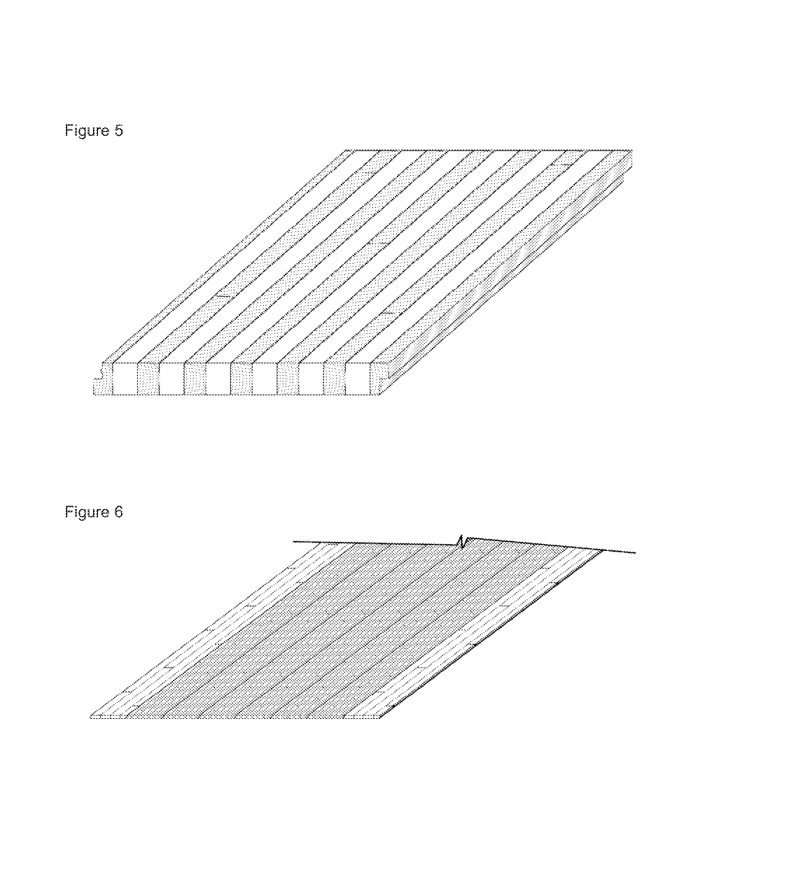

It is preferable that softwood sticks in a laminated floor board are glued between two hardwood sticks. It is also preferable that the sticks on both edges of the floor board are hardwood as shown in FIG. 5; otherwise the softwood edge row must preferably the one where the ship lap is on the top, as in FIG. 4. Another preferable embodiment is that the softwood sticks are not wider than 1,125″ and represent at least 40% of the surface of the floor.

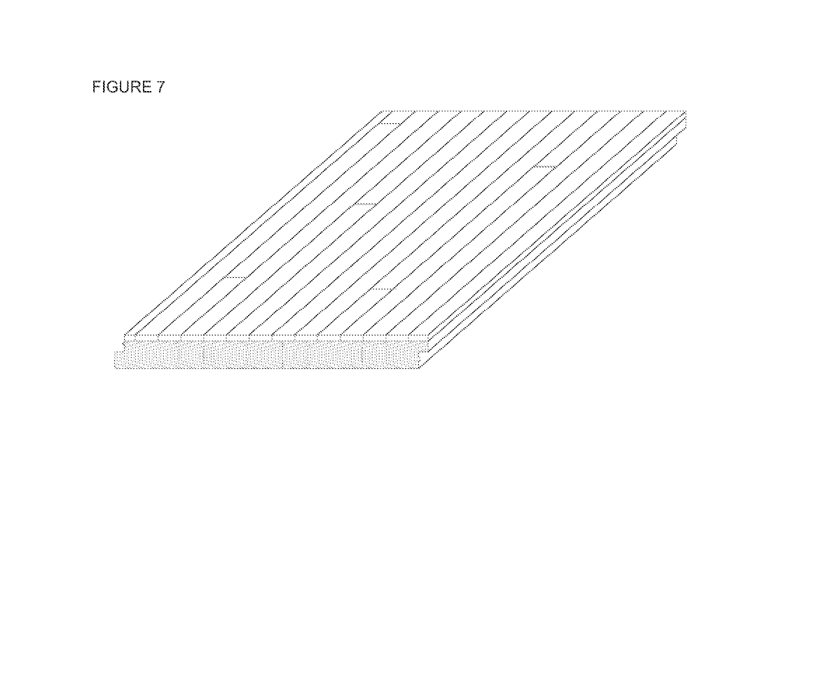

Note that the 100% laminated softwood board (as shown on FIG. 3) can be used on along the wall with the laminated softwood/hardwood floor boards (as shown on the FIGS. 4 and 5) in the middle lie, as shown on the FIG. 6. Considering that such floor would be 1⅜ thick, the weight saving would then be 325 to 390 pounds.

Another design which can be used to get the wear, shock and abrasive resistance of the floor higher enough when softwood is used is to make a 2 layer laminated floor (FIG. 7). The top layer (21) is in hardwood and the bottom layer (23) of the floor is softwood which has been preferably machine-graded. In FIG. 6, the thickness of the hardwood ply could be as low as ⅛″ thick and then the thickness of the softwood part of the floor would be greater to reach the desirable overall thickness of the floor all the while still providing a weight saving. In FIG. 6, the overall thickness of the floor is 1⅜, including a ⅛ hardwood ply glued on the top of a 1¼ softwood bottom core. Note that instead of hardwood, the top layer could be another material like steel, fiberglass, rubber or any other material which increase the wear, shock and abrasive resistance of the softwood bottom core.

The cost to manufacture those floors using machine-graded softwood lumber only or with hardwood are affordable and bring the ratio“$/pound saving” in a range of 0 to 0.50, which is much lower than the current option available to save weight. The present invention will provide benefits of fuel savings and increased payload revenue by weight saving. Because more freight companies will be able to use lighter floors, the benefit for the customer and the economy as a whole will be higher.

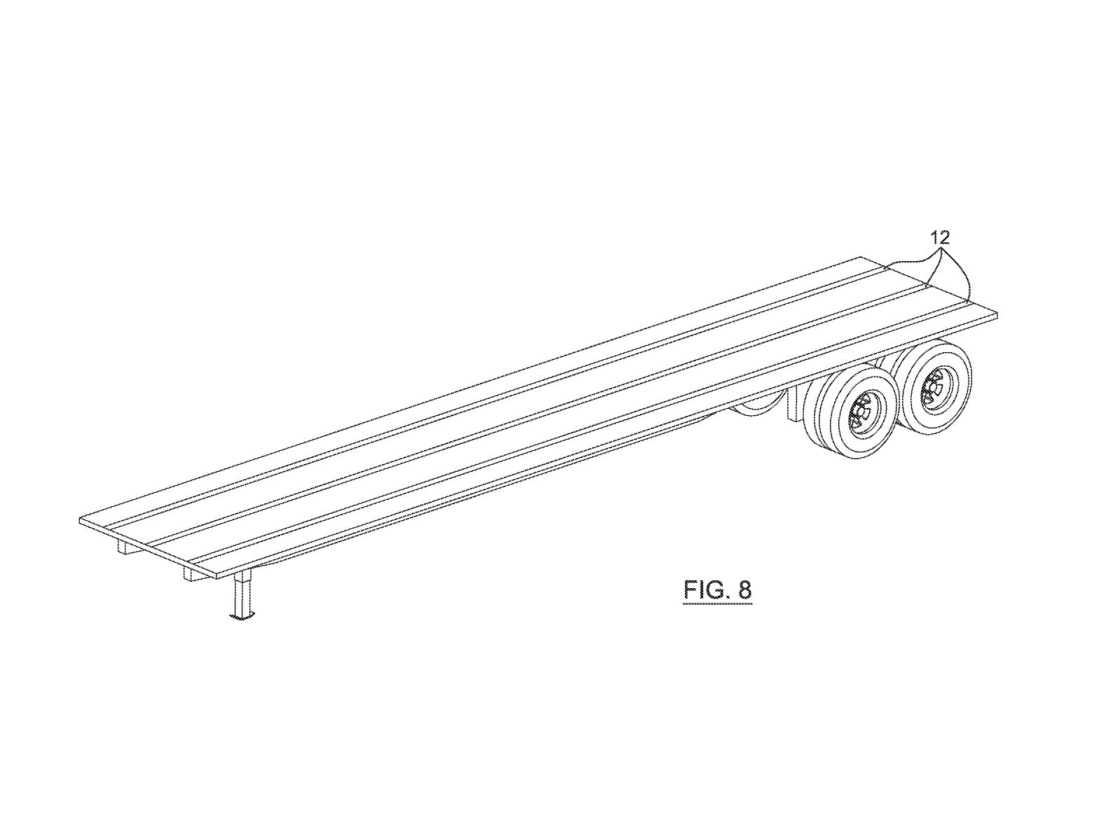

The embodiments above have been described in relation to floor for use mainly in enclosed trailers. However, the present invention can also be used in flatbeds, or platform trailers as shown in FIG. 8.

Indeed, many of the flatbed floors currently being commercialized are made of steel or aluminum. These floors can also include wood portions, sometimes referred to as “nailers”. The nailers are typically hardwood, but can easily be replaced with wood boards or planks constructed along the teachings of the present invention. In FIG. 8, three strips of wood approximately 5″ wide made of machine graded softwood, are installed where Apitong strips would be.

A person skilled in the art will readily understand that the teachings of the present invention is not limited to replacing the for example Apitong strips with strips of machine graded lumber. Indeed, the whole floor of a flatbed trailer can be made of machine graded softwood lumber. Alternatively, a portion, large or small, of the floor can be replaced with machine graded softwood lumber constructed along the teachings therein.

Although the present invention has been explained hereinabove by way of a preferred embodiment thereof, it should be pointed out that any modifications to this preferred embodiment within the scope of the appended claims is not deemed to alter or change the nature and scope of the present invention.

1. A cargo-carrying floor surface system for a cargo-carrying body comprising:
a. a cargo-carrying floor having a longitudinal length and lateral width, said floor comprising:
a plurality of wood boards extending longitudinally up to a length substantially equal to the longitudinal length of said floor, each board having a top surface, a bottom surface opposite said top surface, and first and second side surfaces extending between said top surface and said bottom surface, where each of said wood boards has a width that is less than the lateral width of said floor, each of said wood boards being formed by a plurality of wood strips arranged end-to-end by shaped coupling portions and side-to-side to one another to form rows; said plurality of wood boards being arranged side by side and joined together at adjacent side surfaces to form said floor,
wherein said floor has a top, a bottom opposite said top, first and second sides, a front, a back opposite to said front, a center area between said front and back, a center board area between said first and second sides and an outer board area extending out from said center board area to either said first or second sides;
wherein at least some of said wood strips are machine graded softwood lumber.

2. A floor surface according to claim 1, wherein all of said wood strips are machine graded softwood lumber.

3. A floor surface system according to claim 1, wherein said shaped coupling portions are finger joints.

4. A floor surface system according to claim 1, wherein each of said wood boards is made of alternating rows of hardwood and machine graded softwood lumber.

5. A floor surface system according to claim 1, wherein said boards in said outer board area are made of machine graded softwood lumber, and wherein said boards in said center area are made of hardwood.

6. A floor surface system according to claim 2, wherein said floor surface system further includes a laminated hardwood layer bonded to said top of said floor.

7. A floor surface system according to claim 1, wherein said wood strips that are machine graded softwood lumber represent at least 40% of said floor, by surface area.

8. A floor surface system according to claim 1, wherein said floor surface further includes a hardwood layer bonded to said top of said floor.

9. A cargo-carrying floor surface system for a cargo-carrying body comprising:
a. a cargo-carrying floor having a longitudinal length and lateral width, said floor comprising:
a plurality of wood boards extending longitudinally up to a length substantially equal to the longitudinal length of said floor, each board having a top surface, a bottom surface opposite said top surface, and first and second side surfaces extending between said top surface and said bottom surface, where each of said wood boards has a width that is less than the lateral width of said floor, said plurality of wood boards being arranged side by side and joined together at adjacent side surfaces to form said floor,
wherein said floor has a top, a bottom opposite said top, first and second sides, a front, a back opposite to said front, a center area between said front and back, a center board area between said first and second sides and an outer board area extending out from said center board area to either said first or second sides;
wherein at least one of said planks is formed by a plurality of wood strips arranged end-to-end by shaped coupling portions and side-to-side to one another to form rows, and where some of said wood strips are machine graded softwood lumber.

10. A cargo-carrying floor surface system for a cargo-carrying body comprising:
a. a cargo-carrying floor having a longitudinal length and lateral width, said floor has a top, a bottom opposite said top, first and second sides, a front, a back opposite to said front, a center area between said front and back;
b. said floor including at least a portion thereof that is made of wood, said at least a portion that is wood being formed by a plurality of wood strips arranged end-to-end by shaped coupling portions and side-to-side to one another to form rows, and where some of said wood strips are machine graded softwood lumber.

11. A cargo-carrying floor surface according to claim 10, wherein a remaining portion of said floor surface is made of metal.

12. A cargo-carrying floor surface according to claim 11, wherein said metal is aluminum.

13. A cargo-carrying floor surface according to claim 11, wherein said metal is steel.
